(19) United States
(12) Patent Application Publication
(10) Pub. No.: US 2024/0409214 A1
(43) Pub. Date: Dec. 12, 2024

(54) UNMANNED AERIAL VEHICLE WITH NON-LETHAL NEUROMUSCULAR INCAPACITATION SYSTEM

(71) Applicant: ALBALUX, LLC, EVANSVILLE, IN (US)

(72) Inventors: JON NORD, EVANSVILLE, IN (US); CRAIG KENDALL, EVANSVILLE, IN (US)

(73) Assignee: ALBALUX, LLC, EVANSVILLE, IN (US)

(21) Appl. No.: 18/405,909

(22) Filed: Jan. 5, 2024

Related U.S. Application Data
(63) Continuation-in-part of application No. 17/716,589, filed on Apr. 8, 2022, now abandoned.
Application No. 17/716,589 is a division of application No. 16/669,146, filed on Oct. 30, 2019, now Pat. No. 11,312,493.
(60) Provisional application No. 62/752,441, filed on Oct. 30, 2018.

(51) Int. Cl. B64D 7/00; B64C 39/02; B64U 10/13; B64U 20/30; B64U 50/19; B64U 101/15; B64U 101/45; F41H 13/00

(52) U.S. Cl. CPC B64D 7/00; B64C 39/024; B64U 20/30; B64U 50/19; F41H 13/0025; B64U 10/13; B64U 2101/15; B64U 2101/45

(57) ABSTRACT

The present invention provides an unmanned aerial vehicle with non-lethal neuromuscular incapacitation system comprising a body; a plurality of rotary assemblies secured to the body and configured to provide lift; a control system disposed within the body; a protective cage surrounding the body and the plurality of rotary assemblies; and one or more stinging stickers attached to a periphery of the protective cage. Each of the one or more stinging stickers can deliver an electrical charge. The stinging stickers may be removably attached to the protective cage or they may be fixed to the cage. An electrical charge is delivered from a battery and a power converter positioned on a first portion of the stinging sticker through a high voltage transformer positioned on a second portion of the stinging sticker.

### BACKGROUND OF THE INVENTION

### Field of the Invention

The present invention relates to unmanned aerial vehicles. More specifically, the present invention relates to an unmanned aerial vehicle with a non-lethal neuromuscular incapacitation system that delivers an electric pulse, mace, marking dye or other non-lethal device to incapacitate a person.

### Description of the Related Art

In recent years, unmanned aerial vehicles (UAVs), more commonly known as drones, have been used by law enforcement agencies for a number of specialized purposes including search and rescue operations, traffic collision reconstruction, crime scene analysis, general surveillance and crowd monitoring. UAVs have also been used by law enforcement officers to investigate suspects and locate active shooters that are believed to be “armed and dangerous” while maintaining a safe distance. While this gives officers real-time, actionable intelligence to use to assess the threat and formulate a strategy to respond, it still requires officers to be put into harm's way to diffuse the situation and subdue the shooter.

Accordingly, there is a need for an unmanned aerial vehicle that carries with it a non-lethal neuromuscular incapacitation system that is capable of not only providing officers with intel to assess the threat, but the tools to diffuse the threat without putting officers in harm's way.

### SUMMARY OF THE INVENTION

It is therefore an object of the present invention to provide an unmanned aerial vehicle that carries a non-lethal neuromuscular incapacitation system that is capable of being deployed remotely by officers via a handheld remote control.

The present invention meets this objective by providing an unmanned aerial vehicle that carries an on-board non-lethal incapacitation system. According to one aspect of the invention, a cage surrounds the UAV and a plurality of metal barbs that are connected to a high-voltage pulse supply are carried on the cage and configured to deliver an electrical stun to a person when the metal barbs come into contact with the skin of the target person. Yet another aspect of the invention is a UAV that includes a RF power supply and transmitter system capable of transmitting a narrow beam of electromagnetic energy to heat the skin of the target causing incapacitating pain without causing any permanent damage. A third aspect of the invention is a UAV that is capable of spraying a liquid or powder such as an electrically charged stinging liquid in a mist, mace or a marking dye that will incapacitate or illuminate the target person. A further aspect of the invention is a UAV with an additional rotating element that has electrically charged stingers on the tips thereof that deliver a stunning charge to the target when they come in contact with the target's skin. Yet another aspect of the invention provides a telescoping stinger that can be fired at the subject and, through a connected wire, deliver an electrical shock to the subject when it comes in contact with the subject's body

According to one presently preferred embodiment of the invention, there is provided an unmanned aerial vehicle with non-lethal neuromuscular incapacitation system comprising: a body; a plurality of rotary assemblies secured to the body and configured to provide lift; a control system disposed within said body; a protective cage attached to said body and surrounding said body and said plurality of rotary assemblies; and one or more stinging stickers attached a periphery of the protective cage, each of said one or more stinging stickers further including means for delivering an electrical charge.

According to one aspect of the invention, the stinging sticker is removably attached to the protective cage. The means for delivering an electrical charge may comprise a battery and a power converter positioned on a first portion of the stinging sticker; a high voltage transformer positioned on a second portion of the stinging sticker, said high voltage transformer electrically coupled to said battery and said power converter; and a conductor positioned on the second portion of the stinking sticker and electrically coupled to said high voltage transformer, said conductor configured to deliver a charge to a subject. The means for delivering an electrical charge may further comprise a ground conductor positioned on the first portion of the stinging sticker and electrically coupled to said power converter.

The unmanned aerial vehicle according to this embodiment may further comprise a controller for selectively applying power to the one or more stinging stickers, and a transceiver associated with the controller for receiving wireless signals from a remote control operated by a user remotely from the aerial vehicle and stinging stickers.

The unmanned aerial vehicle may further include a controller for selectively applying power to the one or more stinging stickers, and a transceiver associated with the controller for receiving wireless signals from a remote control operated by a user remotely from the aerial vehicle and stinging stickers. Each of said stinging stickers may comprise a plurality of metal barbs projecting outwardly from the stinging sticker and the protective cage. The metal barbs are electrically coupled to a high voltage pulse supply affixed to the body of the unmanned aerial vehicle.

The plurality of stinging stickers may comprise a plurality of positively charged stinging stickers, the metal barbs of which are electrically coupled to a positive terminal of said high voltage pulse supply, and a plurality of negatively charged stinging stickers, the metal barbs of which are electrically coupled to a negative terminal of said high voltage pulse supply. The plurality of negatively charged stinging stickers are alternatively placed on the protective cage between and adjacent to corresponding positively charged stinging stickers. The metal barbs of said negative stinging stickers may be located in a central area surrounded by a surface with an adhesive thereon.

The unmanned aerial vehicle may include a plurality of stinger assemblies, each having at least one electrode. The protective cage may be attached to the body by a plurality of leaf springs. The protective cage may be spherically shaped.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a top plan view of an unmanned aerial vehicle with a non-lethal neuromuscular incapacitation system according to a first presently preferred embodiment of the invention.

FIG. 2 is a top plan view of an unmanned aerial vehicle with a non-lethal neuromuscular incapacitation system according to a second presently preferred embodiment of the invention.

FIG. 3A is a top plan view of an unmanned aerial vehicle with a non-lethal neuromuscular incapacitation system according to a third presently preferred embodiment of the invention.

FIG. 3B is a close-up view of the portion of FIG. 3A bounded by the box B.

FIG. 4A is a side plan view of an unmanned aerial vehicle with a non-lethal neuromuscular incapacitation system according to a fourth presently preferred embodiment of the invention.

FIG. 4B is a close-up view of the portion of FIG. 4A bounded by the box B.

FIG. 4C is a top plan view of the unmanned aerial vehicle with a non-lethal neuromuscular incapacitation system shown in FIG. 4A.

FIG. 5A is a top plan view of an unmanned aerial vehicle with a non-lethal neuromuscular incapacitation system according to a fifth presently preferred embodiment of the invention.

FIG. 5B is a close-up view of the telescoping stinger of the unmanned aerial vehicle with a non-lethal neuromuscular incapacitation system shown in FIG. 5A.

FIG. 5C is a close-up view of an alternative configuration of the telescoping stinger of the unmanned aerial vehicle with a non-lethal neuromuscular incapacitation system shown in FIG. 5A.

FIG. 6 is a schematic drawing of a wireless stinging sticker for an unmanned aerial vehicle according to a further embodiment of the invention.

### DETAILED DESCRIPTION OF THE INVENTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

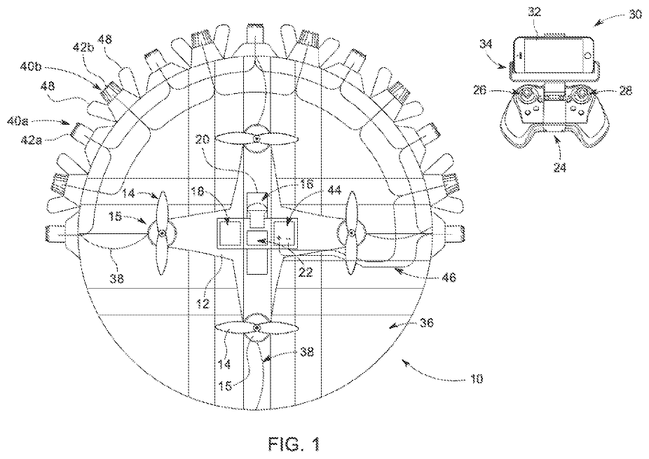

As best shown in FIG. 1 one presently preferred embodiment of the invention comprises an unmanned aerial vehicle (UAV) 10 having a body 12 and a plurality of propellers 14 driven by a corresponding plurality of electric motors 15 as are commonly known in the art for aerial propulsion. The UAV further includes an onboard video camera 16, onboard flight control electronics 18, an onboard power source such as a battery 20, all of which are coupled to a radio control and video transmitter 22 that communicates wirelessly with a handheld remote control unit 24 that is held by the operator. The handheld remote control unit 24 includes a speed control mechanism 26 and a direction control mechanism 28. A first person view (FPV) unit 30 is also provided which, in conjunction with the onboard video camera 16 radio control and video transmitter 22 displays the images from the onboard camera 16 on a liquid crystal display (LCD) 32 located on the FPV unit 30. A strap 34 may also be provided to tether the FPV unit 30 to the operator. The battery 20 powers the electric motors 15 coupled to the propellers 14 as well as the camera 16 and flight control electronics 18.

A protective cage 36 surrounds the UAV 10 and is attached to the UAV body 12 by a plurality of connectors such as leaf springs 38 having a first end attached to the protective cage 36 and a second end attached to the UAV body 12. The protective cage 36 is preferably formed of a plurality of criss-crossed wires that surround the UAV body 12, but can consist of any configuration that surrounds the UAV body 12 and propellers 14 providing a protective cage. Preferably, the cage 36 is spherical or ball-shaped, although other shapes are certainly contemplated.

A plurality of stinging stickers 40 are attached to the periphery of the cage 36. Each of the stinging stickers 40 includes a plurality of metal hooks or barbs 42 that, when they come into contact with an object such as human skin, engage and penetrate the surface of the skin. Although numerous configurations of stinging stickers could be used, FIG. 1 depicts two different types of stinging stickers 40a, 40b, shown in FIG. 1 in a alternating pattern. The first type of stinging sticker 40a includes a plurality of metal hooks or barbs 42a that are electrically coupled to the positive terminal of a power source 44, while the plurality of metal hooks or barbs 42b on the second type of stinging sticker 40b are electrically coupled to the negative terminal of the power source 44 such that, when activated, an arc of electricity is generated between adjacent stinging stickers 40a, 40b. The stinging stickers 40a, 40b are activated when the barbs 42a, 42b are in close proximity to the target person such that the arc of electricity delivers a charge to the suspect once the barbs 42a, 42b are in close proximity to the skin of the target. The plurality of metal barbs 42a are electrically coupled to the positive terminal of a high voltage pulse supply 44 that is carried on the UAV body 12 via electrical leads 46. A plurality of stinging stickers 40a may be provided and connected in series as shown in FIG. 1. The second type of stinging strikers 40b include a plurality of metal hooks or barbs 42b located in a central area surrounded by a surface with an adhesive thereon.

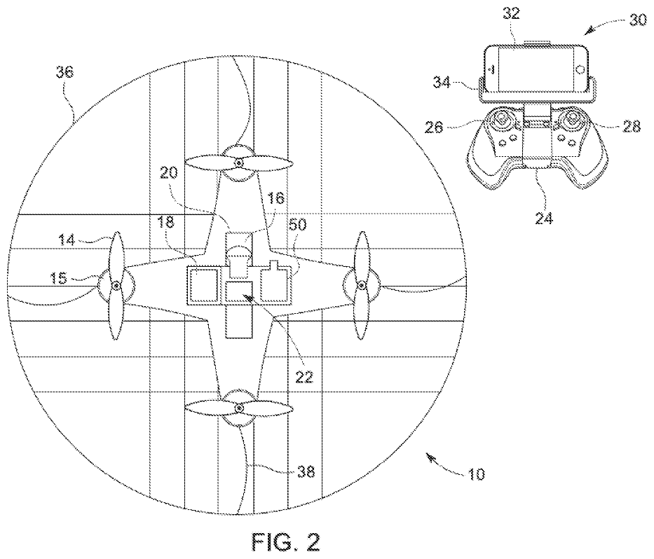

An alternative embodiment of the present invention is shown in FIG. 2. Many of the components of the UAV 10 are the same or similar to those in the first embodiment and like reference numerals are used here to indicate like component parts. The UAV according to the second embodiment includes a RF power supply and RF transmitter 50 that is capable of transmitting a narrow beam of electromagnetic energy to heat the skin without causing any permanent damage. The beam is sent out at the speed of light by the transmitter. An intense burning sensation continues until the transmitter is turned off or the targeted individual moves outside of the beam's range.

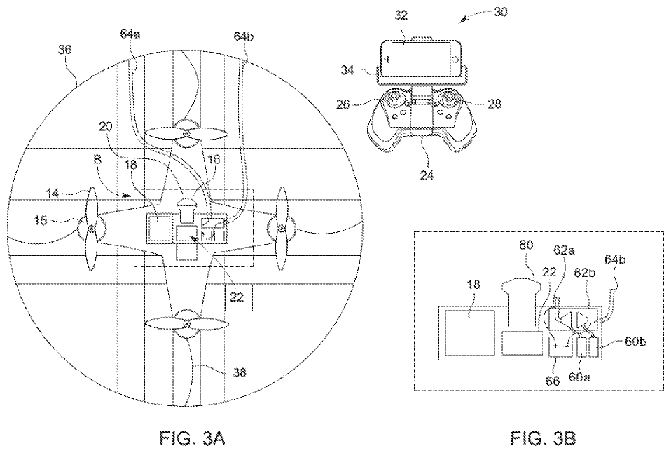

A further alternative embodiment of the invention is shown in FIG. 3A and FIG. 3B. Again, many of the components of the UAV 10 are the same or similar to those in the previous embodiments and like reference numerals are used here to indicate like component parts. The UAV according to the third embodiment includes a mechanism for discharging a liquid or powder substance at the target. The liquid/powder discharging mechanism includes one or more reservoirs 60a, 60b for holding the liquid or powder to be discharged. A pump 62a, 62b is associated with each reservoir 60a, 60b to draw the liquid or powder from the reservoirs 60a, 60b and direct it into tubes 64a, 64b. The free ends of tubes 64a, 64b are positioned at the periphery of the cage 36 to discharge the liquid or powder at the target when the UAV is in close proximity. Power is provided to power the pumps 62a, 62b by the main battery 20. A high voltage power supply 66 has a positive post connected by a lead wire to the first tube 64a and a a negative post connected by a lead wire to the second tube 64b. The first and second tubes 64a, 64b are preferably formed from an electrically conductive material such that when the stinging liquid is discharged from the end of the tubes 64a, 64b it forms a mist which become electrically charged upon actuation of the high voltage power source via electricity passing through the electrically conductive tubes 64a, 64b and the mist which spans the area around the free ends of the tubes 64a, 64b.

According to one aspect of the third embodiment, the liquid used is a stinging liquid and the liquid reservoirs are conductive liquid reservoirs, one being positively charged and the other negatively charged. Alternatively, the liquid reservoirs could contain mace. Still further, a marking dye could be contained in the reservoirs such that an ultraviolet or colored dye is discharged from the ends of the tubes 64a, 64b.

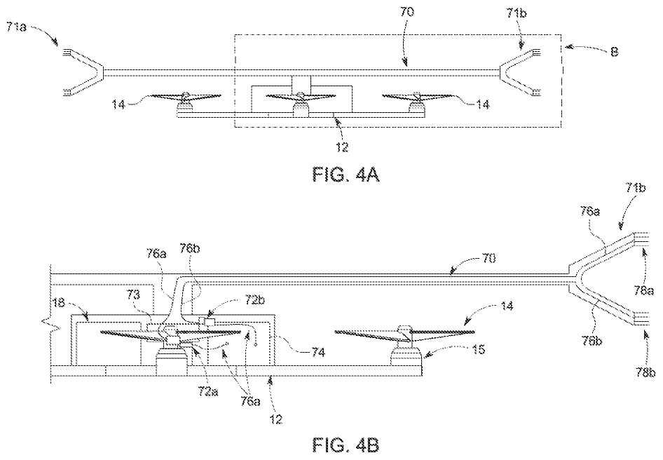

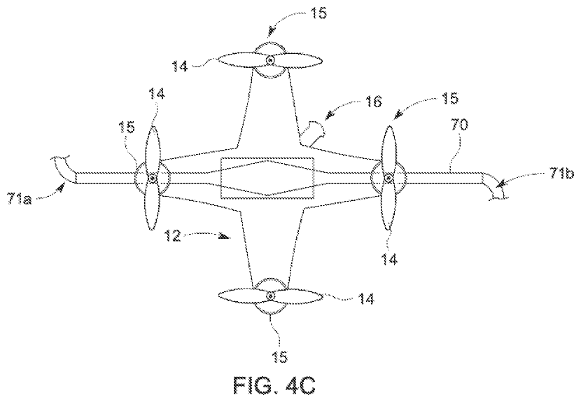

A fourth embodiment of the present invention, as shown in FIGS. 4A-4C, includes a rotary sting arm 70 connected to the UAV body 12 by a rotary brush high-voltage connection 72 and powered by a sting arm motor 73 mounted at or near the center of the UAV body 12. The main components of the UAV 10 are the same as in previous embodiments were like reference numerals indicate like components. Each end of the rotary stinging arm 70 has a stinger element 71a, 71b that is configured to deliver a stinging charge when it comes into contact with the skin of a target. A high voltage power supply 74 positioned on the UAV body 12 supplies power to the stinger elements 71a, 71b. A first lead wire 76a has a first end attached to a positive post of the high voltage power supply 74 while a second lead wire 76b has a first end attached to a negative post of the high voltage power supply. The lead wires 76a, 76b are connected to electrical contacts 72a, 72b that are a part of the rotary brush high-voltage connection 72 so that power can be delivered to the stinger elements while the rotary sting arm 70 is in rotary motion without the lead wires 76a, 76b becoming entangled. The distal end of the lead wires 76a, 76b are connected to stinging barbs 78a, 78b, respectively, that are positioned at the outer ends of the stinger elements 71a, 71b.

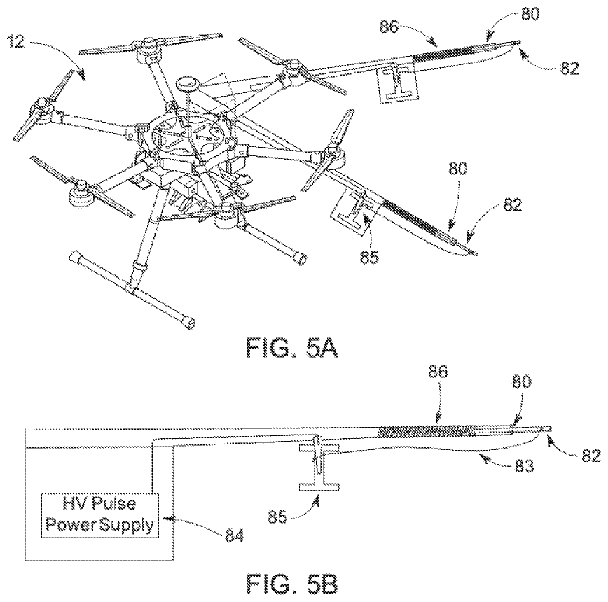

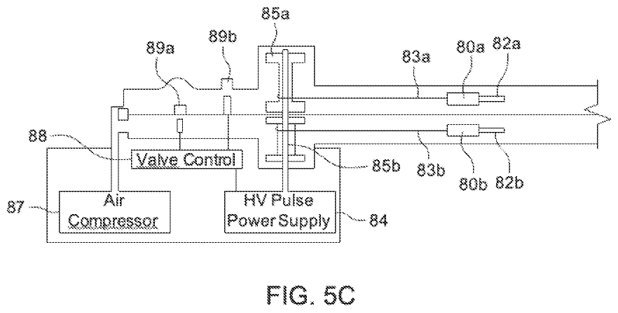

A fifth embodiment of the present invention, shown in FIGS. 5A-5B, includes a telescoping stinger 80 that can be fired at a target within range of the UAV body 12. The telescoping stinger 80 may be equipped with an electrode barb 82 at the end thereof which is connected by a wire 83 to a high voltage pulse power supply 84. A spool 85 may also be provided about which the wire 83 can be wound, and, subsequently unwound as the telescoping stinger 80 with the end of the wire 83 attached is fired at and moves toward the target. The telescoping stinger in inserted into a barrel that has a spring 86 located therein. The stinger 80 compresses the spring 86 and locks the stinger 80 into position with the spring 86 compressed. When the user actuates a trigger switch (not shown) on the handheld remote control unit 24, the spring 86 is released and the stinger 80 fired toward the target.

FIG. 5C shows an alternative firing mechanism for the fifth embodiment wherein a pair of telescoping stingers 80a, 80b having electrode barbs 82a, 82b, respectively, are loaded into barrels and have electrical lead wires 83a, 83b which connect them to a high pulse power supply 84. Spools 85a, 85b may also be provided about which the wires 83a, 83b can be wound, and, subsequently unwound as the telescoping stingers 80a, 80b with the end of the wires 83a, 83b attached are fired at and move toward the target. An air compressor 87 and valve controller 88 serve to open and close valves 89a, 89b and deliver a burst of compressed air to the barrel(s) causing the stinger(s) 80a, 80b to be discharged toward the target upon actuation of the trigger switch (not shown) by the user on the handheld remote control unit 24.

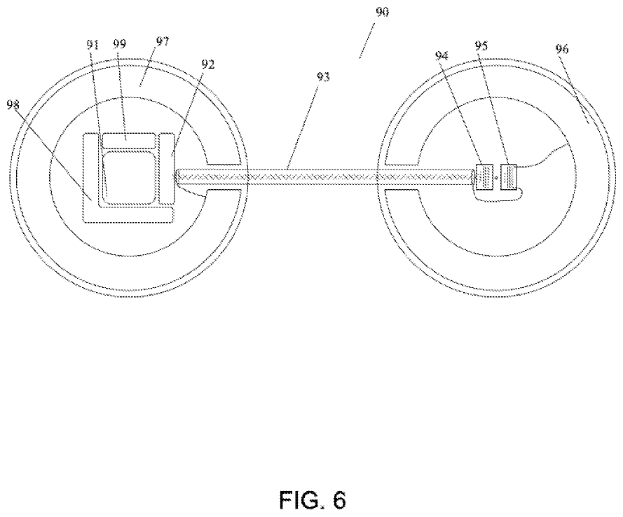

FIG. 6 shows an alternative, wireless stinging sticker 90 for delivering an electrical charge to a subject. A plurality of wireless stinging stickers 90 can be attached to the periphery of the cage 36 of the UAV 10 in the same manner and configuration as the stinging stickers 40 shown in FIG. 1. Like the stinging stickers 40, each of the wireless stinging stickers may include a plurality of metal hooks or barbs that, when they come into contact with an object such as human skin, engage and penetrate the surface of the skin. Unlike the stinging stickers 40, the wireless stinging stickers 90 are removably attached to the cage 36. In operation, the UAV 10 is piloted to the subject at which time one or more wireless stinging stickers 90 are placed in contact with the subject's skin. The metal hooks or barbs engage the subject's skin. The wireless stinging sticker 90 is removably affixed to the cage 36. When the UAV moves away from the subject, the wireless stinging sticker 90 that is attached to the subject detaches from the cage 36.

The wireless stinging sticker 90 includes a power supply such as a battery 91. The battery supplies volage to a converter 92. The converter 92 is electrically coupled to a high voltage transformer 94 by a twisted pair of wires 93. The transformer 94 is preferably in the range of 600 volts, and is connected ot a step-up transformer 95 designed to step up voltage to approximately 50,000 volts in an open circuit. The step-up transformer 95 is electrically coupled to a conductor 96, which, when placed in contact with the subject's skin, can be used to deliver the charge. A ground conductor 97 is provided that is also designed to be in contact with the subject's skin when the charge is applied to complete the circuit.

The wireless stinging sticker 90 further includes a controller 98 and a transceiver 99. Once the wireless stinging sticker 90 has been placed on the subject and the UAV has moved away, the operator holding the remote control 24 can send a signal to to apply a charge. The signal is received at the transceiver 96, and the control circuitry 98 then causes a charge to be applied.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

I/We claim:

1. An unmanned aerial vehicle with non-lethal neuromuscular incapacitation system comprising:
a. a body;
b. a plurality of rotary assemblies secured to the body and configured to provide lift;
c. a control system disposed within said body;
d. a protective cage attached to said body and surrounding said body and said plurality of rotary assemblies; and
e. one or more stinging stickers attached a periphery of the protective cage, each of said one or more stinging stickers further including means for delivering an electrical charge.

2. The unmanned aerial vehicle of claim 1, wherein said stinging sticker is removably attached to the protective cage.

3. The unmanned aerial vehicle of claim 2, wherein said means for delivering an electrical charge comprises:
a. A battery and a power converter positioned on a first portion of the stinging sticker;
b. A high voltage transformer positioned on a second portion of the stinging sticker, said high voltage transformer electrically coupled to said battery and said power converter; and
c. a conductor positioned on the second portion of the stinking sticker and electrically coupled to said high voltage transformer, said conductor configured to deliver a charge to a subject.

4. The unmanned aerial vehicle of claim 3 wherein the means for delivering an electrical charge further comprises a ground conductor positioned on the first portion of the stinging sticker and electrically coupled to said power converter.

5. The unmanned aerial vehicle of claim 3 further comprising:
a. a controller for selectively applying power to the one or more stinging stickers, and
b. a transceiver associated with the controller for receiving wireless signals from a remote control operated by a user remotely from the aerial vehicle and stinging stickers.

6. The unmanned aerial vehicle of claim 1 further comprising:
a. a controller for selectively applying power to the one or more stinging stickers, and
b. a transceiver associated with the controller for receiving wireless signals from a remote control operated by a user remotely from the aerial vehicle and stinging stickers.

7. The unmanned aerial vehicle of claim 1, wherein each of said stinging stickers comprising a plurality of metal barbs projecting outwardly from the stinging sticker and the protective cage, said metal barbs further being electrically coupled to a high voltage pulse supply affixed to the body of the unmanned aerial vehicle.

8. The unmanned aerial vehicle of claim 7, wherein said plurality of stinging stickers comprises a plurality of positively charged stinging stickers, the metal barbs of which are electrically coupled to a positive terminal of said high voltage pulse supply, and a plurality of negatively charged stinging stickers, the metal barbs of which are electrically coupled to a negative terminal of said high voltage pulse supply, said plurality of negatively charged stinging stickers being alternatively placed on the protective cage between and adjacent to corresponding positively charged stinging stickers.

9. The unmanned aerial vehicle of claim 8, wherein the metal barbs of said negative stinging stickers are located in a central area surrounded by a surface with an adhesive thereon.

10. The unmanned aerial vehicle according to claim 1, wherein said unmanned aerial vehicle includes a plurality of stinger assemblies, each having at least one electrode.

11. The unmanned aerial vehicle of claim 1, wherein said protective cage is attached to said body by a plurality of leaf springs.

12. The unmanned aerial vehicle of claim 2, wherein said protective cage is spherically shaped.

13. A wirelessly controlled lightweight stinging sticker for delivering an electrical charge to a subject comprising:
a. a battery and a power converter positioned on a first portion of the stinging sticker;
b. a high voltage transformer positioned on a second portion of the stinging sticker, said high voltage transformer electrically coupled to said battery and said power converter; and
c. a conductor positioned on the second portion of the stinking sticker and electrically coupled to said high voltage transformer, said conductor configured to deliver a charge to a subject.

14. The wirelessly controlled lightweight stinging sticker of claim 13 further comprises a ground conductor positioned on the first portion of the stinging sticker and electrically coupled to said power converter.

15. The wirelessly controlled lightweight stinging sticker of claim 13 further comprising:
a. a controller for selectively applying power to the one or more stinging stickers, and
b. a transceiver associated with the controller for receiving wireless signals from a remote control operated by a user remotely from the stinging stickers.
